(19) United States
(12) Patent Application Publication
(10) Pub. No.: US 2026/0252956 A1
(43) Pub. Date: Aug. 27, 2026

(54) REINFORCEMENT LEARNING METHOD AND APPARATUS USING TRUNCATED NORMAL DISTRIBUTION-BASED POLICY FOR MITIGATING ACTION BIAS IN CONTINUOUS ACTION REINFORCEMENT LEARNING

(71) Applicant: SEOUL NATIONAL UNIVERSITY R&DB FOUNDATION, Seoul (KR)

(72) Inventors: Kanghoon LEE, Seoul (KR); Minji KIM, Seoul (KR); Minsu LEE, Seoul (KR); Byoung-Tak ZHANG, Seoul (KR)

(21) Appl. No.: 19/431,779

(22) Filed: Dec. 23, 2025

(30) Foreign Application Priority Data
Feb. 25, 2025 (KR) 10-2025-0024621

(51) Int. Cl. G06N 20/00

(52) U.S. Cl. CPC G06N 20/00

(57) ABSTRACT

Embodiments relate to a reinforcement learning method and apparatus. The reinforcement learning method is performed by a reinforcement learning apparatus. The reinforcement learning method includes, setting a truncated normal distribution, which is a normal distribution having a finite domain, for a policy in which the relationship between the states and actions of reinforcement learning is defined, and determining actions according to the policy set with the truncated normal distribution.

### CROSS-REFERENCE TO RELATED APPLICATION

This application claims the benefit of Korean Patent Application No. 10-2025-0024621 filed on Feb. 25, 2025, which is hereby incorporated by reference herein in its entirety.

### BACKGROUND

### 1. Technical Field

The embodiments disclosed herein relate to a reinforcement learning method and apparatus, and more particularly to a reinforcement learning method and apparatus that mitigate action bias while maximally preserving characteristics of a normal distribution by using a policy based on a truncated normal distribution obtained by modifying characteristics of the normal distribution.

The embodiments disclosed herein were contrived as a result of research under projects (Nos. 11211343, 11220951, 11220953, and 11212068) of the Institute of Information & Communications Technology Planning & Evaluation (IITP), projects (Nos. 00274280, 00358416, and 00353991) of the National Research Foundation of Korea (NRF), and a project (No. 00423940) of the Korea Planning & Evaluation Institute of Industrial Technology (KEIT).

### 2. Description of the Related Art

In conventional reinforcement learning environments using continuous actions, policies based on normal distributions are commonly used. In reinforcement learning, a policy is the rules defined to determine the actions that an agent will take when faced with given states. When a reinforcement learning model selects actions according to a policy based on a normal distribution, it probabilistically extracts actions from the learned normal distribution. Since the normal distribution has an infinite real-valued domain, the number of actions that can be extracted is theoretically infinite. However, in real-world environments (e.g., the motor output values of a robot), the range of actions is frequently limited. Therefore, policies based on normal distributions may not be directly applied in these environments.

To take into consideration the finite range of actions in real environments, there is used a clipping method of clipping extracted values within a usable range as in the Proximal Policy Optimization (PPO) algorithm. This clipping method distorts the probabilities of actions. In particular, a learning policy lacks information about a clipping process, and thus, a problem arises in that actions are biased toward the bounds of the usable range in the real environments.

Therefore, there is a demand for technology that may mitigate the distortion of action probabilities while taking into consideration the limitations of real environments in reinforcement learning.

For reference, Korean Patent Application Publication No. 10-2022-0014744 (published on Feb. 7, 2022) is directed to a data preprocessing system and method based on reinforcement learning. This patent only discloses general information about a policy network technology based on a normal distribution, but does not provide a technology for mitigating action bias in reinforcement learning.

### SUMMARY

An object of the embodiments disclosed herein is to prevent actions from being biased in reinforcement learning by setting a truncated normal distribution, which is a normal distribution having a finite domain, for a policy in which the relationship between the states and actions of reinforcement learning is defined and then determining actions according to the policy set with the truncated normal distribution.

Other objects and advantages of the present invention may be understood from the following description, and will be more clearly understood via embodiments. Furthermore, it will be readily apparent that the objects and advantages of the present invention may be realized by the means and combinations thereof set forth in the claims.

According to an aspect of the present invention, there is provided a reinforcement learning method, the reinforcement learning method being performed by a reinforcement learning apparatus, the reinforcement learning method including: setting a truncated normal distribution, which is a normal distribution having a finite domain, for a policy in which the relationship between the states and actions of reinforcement learning is defined; and determining actions according to the policy set with the truncated normal distribution.

According to another aspect of the present invention, there is provided a reinforcement learning apparatus including: memory configured to store a truncated normal distribution, which is a normal distribution having a finite domain, for a policy in which the relationship between the states and actions of reinforcement learning is defined; and a controller configured to determine the actions according to the policy set with the truncated normal distribution.

According to still another aspect of the present invention, there is provided a non-transitory computer-readable storage medium having stored thereon a program for performing the reinforcement learning method.

According to still another aspect of the present invention, there is provided a computer program stored on a storage medium to perform the reinforcement learning method, the computer program being executed by a reinforcement learning apparatus.

According to any one of the above-described solutions, there may be proposed the reinforcement learning method and apparatus that may mitigate the bias of actions toward the boundaries by setting a truncated normal distribution for a policy in which the relationship between the states and actions of reinforcement learning is defined and extracting actions within bounds according to the policy set with the truncated normal distribution.

Furthermore, according to any one of the above-described solutions, there may be proposed the reinforcement learning method and apparatus that may mitigate and thus balance the bias in which actions are excessively concentrated within the boundaries by applying a scale-adjustment function that adjusts the degree of scale adjustment of the scale parameter of a truncated normal distribution based on the location parameter of the truncated normal distribution and bounds.

The effects of the disclosed embodiments are not limited to the effects mentioned above, and other effects not mentioned may be clearly understood by those having ordinary skill in the art to which the disclosed embodiments pertain from the following description.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a block diagram of a reinforcement learning apparatus according to an embodiment;

FIG. 2 is a diagram conceptually illustrating the learning operation of a reinforcement learning apparatus according to an embodiment;

FIGS. 3 to 5 are graphs illustrating the truncated normal distribution policies processed by a reinforcement learning apparatus according to an embodiment;

FIG. 6 is a graph illustrating the scale-adjustment functions processed by a reinforcement learning apparatus according to an embodiment.

FIG. 7 is a graph illustrating truncated normal distribution policies to which the scale-adjustment functions processed by a reinforcement learning apparatus according to an embodiment are applied; and

FIGS. 8 to 10 are flowcharts illustrating a reinforcement learning method according to an embodiment.

### DETAILED DESCRIPTION

Various embodiments will be described in detail below with reference to the accompanying drawings. The following embodiments may be modified to various different forms and then practiced. In order to more clearly illustrate features of the embodiments, detailed descriptions of items that are well known to those having ordinary skill in the art to which the following embodiments pertain will be omitted. Furthermore, in the drawings, portions unrelated to descriptions of the embodiments will be omitted. Throughout the specification, like reference symbols will be assigned to like portions.

Throughout the specification, when one component is described as being “connected” to another component, this includes not only a case where the one component is ‘directly connected’ to the other component but also a case where the one component is ‘connected to the other component with a third component arranged therebetween.’ Furthermore, when one portion is described as “including” one component, this does not mean that the portion does not exclude another component but means that the portion may further include another component, unless explicitly described to the contrary.

Embodiments will be described in detail below with reference to the accompanying drawings.

First, the terms used herein will be described as follows:

Reinforcement learning (RL) is a machine learning method in which learning is performed based on experience through interaction and actions or action sequences maximizing rewards are selected. Reinforcement learning is performed to recognize states, to perform actions according to a policy, and to obtain rewards in a given environment. Since subsequent states cannot be known in advance, such learning is called model-free reinforcement learning. Representative deep learning-based model-free reinforcement learning algorithms include Proximal Policy Optimization (PPO), Deep Q-Networks (DQN), and Asynchronous Advantage Actor Critic (A3C).

An agent, which is the subject of reinforcement learning, learns a decision-making strategy that maximizes rewards, and the ultimate goal of the agent is to maximize the expected value of the sum of rewards. In other words, the agent is trained to select the optimal actions that maximize rewards.

In reinforcement learning, sampling is used because it is impossible to determine the values of all states. The agent learns about an environment by experiencing these samples.

An episode in reinforcement learning refers to a series of steps including states, actions, and rewards that an agent has experienced from an initial state to a final state. In reinforcement learning, after an episode has been finished, information about the actions taken in previous states is recorded. This recorded information may be considered a form of experience. The recorded information is used to make decisions in a subsequent episode. An update process is repeated by recording the information obtained from an episode after the corresponding episode has been finished.

The criteria used by the agent of reinforcement learning to make decisions are called a policy. Most deep learning-based reinforcement learning algorithms require numerous trials and errors to learn a policy.

Reinforcement learning is utilized as a promising decision-making model for solving a wide range of challenging problems, including gaming, robotics, locomotion, visual tasks, recommendation systems, automation, and language model learning. In these diverse applications, tasks are typically divided into two categories: discrete and continuous. Discrete actions are sampled from categorical distributions, while continuous actions are typically sampled from density distributions such as a noise or Gaussian distribution.

In continuous domains, reinforcement learning policies are based on normal distributions (Gaussian distributions) for their generality. In continuous domain, normal distribution (Gaussian distribution) policies are dominant due to their strong generality and mathematical advantages, such as differentiability, appropriate stochasticity for continuous actions, and simple, intuitive parameters like location and scale, which are advantageous for modulating exploration and exploitation.

However, the unbounded support of Gaussian policy may cause a bias toward sampling boundary actions in many continuous control tasks that impose action limits due to physical constraints. This “boundary action bias” may negatively impact learning in algorithms such as Proximal Policy Optimization (PPO).

To overcome the problems of conventional normal distribution policies, a reinforcement learning apparatus according to an embodiment performs reinforcement learning by using two major policies:

First, the present embodiment performs reinforcement learning by using a truncated normal distribution policy as an alternative for regulating boundary actions. The present embodiment employs a truncated normal distribution policy having inherent boundaries to mitigate bias. A plain truncated normal distribution policy prefers interior actions, resulting in counter-bias.

Second, the present embodiment performs reinforcement learning by using a scale-adjusted truncated normal distribution policy to balance the tendency of boundary actions because a plain truncated normal distribution policy reduces boundary actions but can be over-regulatory. To balance the bias, the present embodiments may use a scale-adjusted truncated normal distribution policy, which makes the distribution scale shrink when the location is near the boundaries. The scale-adjusted policy may successfully balance boundary bias and counter bias.

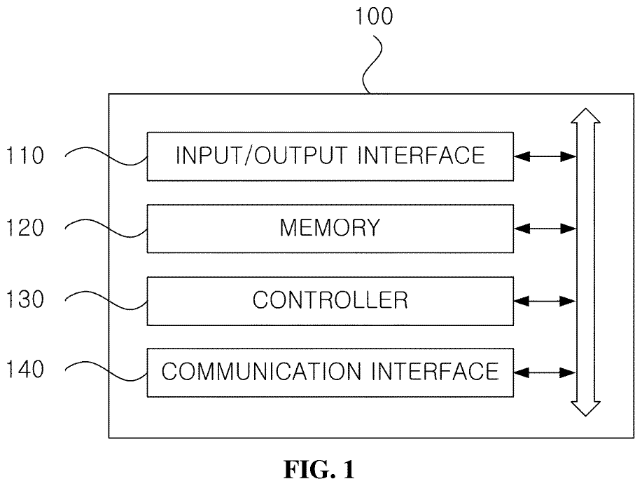

FIG. 1 is a block diagram of a reinforcement learning apparatus according to an embodiment.

Referring to FIG. 1, a reinforcement learning apparatus 100 according to an embodiment may include an input/output interface 110, memory 120, a controller 130, and a communication interface 140.

The input/output interface 110 may include an input interface configured to receive input from a user, and an output interface configured to display information, such as task execution results, the status of the reinforcement learning apparatus 100, and/or the like. In other words, the input/output interface 110 is configured to receive data and output the results of computational processing of the received data. The reinforcement learning apparatus 100 according to the embodiment may receive requests for bundle recommendations, and/or the like via the input/output interface 110.

The memory 120 is configured to store files and programs, and may be constructed using various types of memory. In particular, the memory 120 may store data and programs that enable the controller 130, to be described below, to perform operations for reinforcement learning according to the algorithm to be presented below.

The memory 120 may store a reinforcement learning model. The memory 120 may store the states, actions, and policy of a reinforcement learning environment. The memory 120 may store truncated normal distributions (a plain truncated normal distribution, and a scale-adjusted truncated normal distribution) to be applied to the policy. The memory 120 may store the location and scale parameters of the truncated normal distribution. The memory 120 may also store a scale-adjustment function that adjusts the degree of scale adjustment of the truncated normal distribution.

The controller 130 is configured to include at least one processor, such as a central processing unit (CPU) or a graphics processing unit (GPU), and may control the overall operation of the reinforcement learning apparatus 100. That is, the controller 130 may control other components included in the reinforcement learning apparatus 100 to perform operations for reinforcement learning. The controller 130 may execute a program stored in the memory 120 to perform operations for determining actions based on the truncated normal distribution policy according to the algorithm to be presented below.

The communication interface 140 may perform wired/wireless communication with other devices or a network. For example, when a server providing services for a specific platform that collects or processes environmental data is implemented as a separate device, the communication interface 140 may receive environmental information through communication with the server providing the services of the platform. Furthermore, the communication interface 140 may provide the actions, predicted based on the received environmental information, to the server or the terminal of a user.

To this end, the communication interface 140 may include a communication module configured to support at least one of various wired/mobile or wireless communication methods, and the communication module may be implemented in the form of a chipset. The mobile or wireless communication supported by the communication interface 140 may include, for example, N-generation mobile communication protocols, Wireless Fidelity (WiFi), Wi-Fi Direct, Bluetooth, Ultra-Wide Band (UWB), or Near Field Communication (NFC).

The controller 130 may set a truncated normal distribution, which is a normal distribution having a finite domain, for a policy in which the relationship between the states and actions of reinforcement learning is defined. The controller 130 may determine actions according to the policy set with the truncated normal distribution.

When the controller 130 needs to primarily limit actions (operations) within the boundaries of reinforcement learning, the controller 130 can improve the processing speed of the reinforcement learning apparatus while also improving its sampling accuracy by calling the plain truncated normal distribution policy from the memory 120 and primarily setting the reinforcement learning policy by changing it from the normal distribution policy to the plain truncated normal distribution policy.

When the controller 130 needs to secondarily limit actions (operations) within the boundaries of reinforcement learning, the controller 130 can further improve the processing speed of the reinforcement learning apparatus while also further improving its sampling accuracy by calling the scale-adjusted truncated normal distribution policy from the memory 120 and secondarily setting the reinforcement learning policy by changing it from the plain truncated normal distribution policy to the scale-adjusted truncated normal distribution policy.

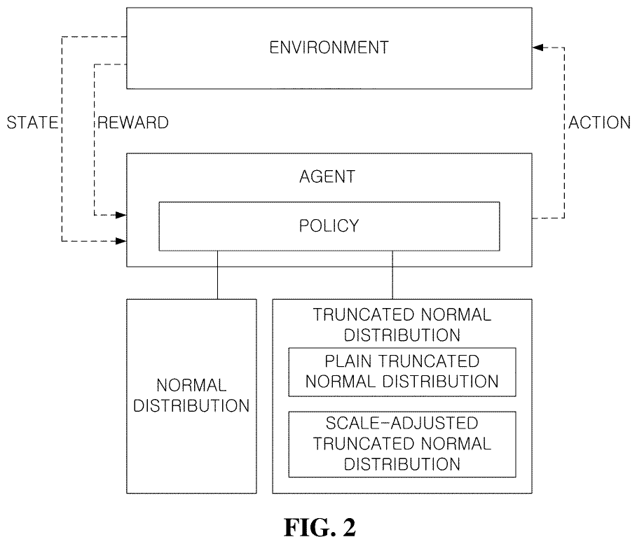

FIG. 2 is a diagram conceptually illustrating the learning operation of a reinforcement learning apparatus according to an embodiment.

The reinforcement learning apparatus may select a policy. The reinforcement learning apparatus selects the policy based on a truncated normal distribution. During the process of setting a truncated normal distribution, the reinforcement learning apparatus may set the location and scale parameters of the truncated normal distribution and set bounds for the minimum and maximum values of actions.

When setting a truncated normal distribution, the reinforcement learning apparatus may apply a scale-adjustment function that adjusts the degree of scale adjustment of the scale parameter of the truncated normal distribution based on the location parameter of the truncated normal distribution and the bounds. In the process of applying the scale-adjustment function, the action bias is controlled by adjusting the kurtosis of the scale-adjustment function, and the action bias may be controlled by adjusting the minimum value of the scale-adjustment function.

The reinforcement learning apparatus may probabilistically extract actions according to the policy set with the truncated normal distribution, to which the scale-adjustment function is applied, in the process of determining the actions based on the policy.

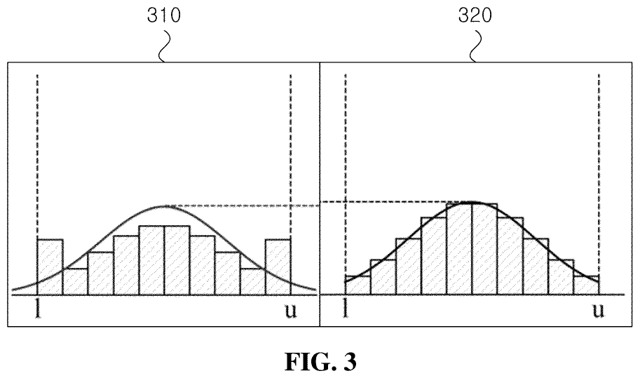

FIGS. 3 to 5 are graphs illustrating the truncated normal distribution policies processed by a reinforcement learning apparatus according to an embodiment.

The truncated normal distribution is expressed by the mean μ, which is the same location parameter as that of a normal distribution, and the standard deviation σ, which is a scale parameter. The truncated normal distribution has a domain (1≤x≤u) within sample bounds. In this case, l and u represent the minimum value (lower bound) and maximum value (upper bound) of actions, respectively, set in an environment. Accordingly, when a policy based on a truncated normal distribution is used, it may be possible to perform reinforcement learning while maximally preserving characteristics of the normal distribution without undergoing an additional process.

FIG. 3 shows graphs illustrating a normal distribution 310 and a truncated normal distribution 320 when a location parameter μ is centered within two bounds. μ=(u+l)/2, and σ=0.5.

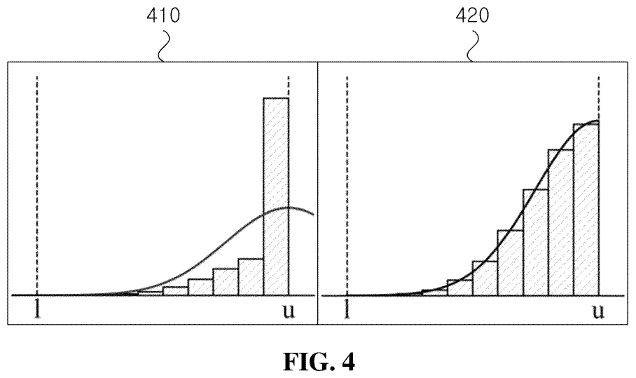

FIG. 4 shows graphs illustrating a normal distribution 410 and a truncated normal distribution 420 when a location parameter μ is at an upper limit bound. μ=u, and σ=0.5.

The graphs of FIGS. 3 and 4 represent probabilities on an interval basis. The hatched bars represent the probabilities of actions extracted by a probability density function (PDF).

In the normal distributions 310 and 410, actions outside the bounds are extracted, so that a clipping technique is applied, with the result that the action probabilities are distorted. In contrast, the truncated normal distributions 320 and 420 do not require the clipping of actions, so that the consistency between the PDF and the action probabilities is preserved. In other words, actions are extracted only within bounds, so that there is no room for distortion. Furthermore, the areas under the PDFs need to be equal to 1, and thus, the truncated normal distributions 320 and 420 are taller than the normal distributions 310 and 410, respectively.

The truncated normal distribution is a distribution designed to have the finite domain l≤x≤u, and has a PDF, such as that shown in Equation 1.

$$f ( x ; μ , σ , l , u ) = \frac{1}{σ} \cdot \frac{φ ( \frac{x - μ}{σ} )}{Φ ( \frac{u - μ}{σ} ) - Φ ( \frac{l - μ}{σ} )} \qquad ( 1 )$$

$$φ ( x ) = \frac{1}{\sqrt{2 π}} exp ( - \frac{1}{2} {x}^{2} ) \qquad ( 2 )$$

$$Φ ( x ) = \frac{1}{2} ( 1 + erf ( x / \sqrt{2} ) ) \qquad ( 3 )$$

As shown in Equation 4 below, when the inverse of the cumulative distribution function (CDF) of the PDF is used, samples of a truncated normal distribution may be easily extracted from x extracted from a distribution.

$${F}^{- 1} ( x ; μ , σ , l , u ) = {Φ}^{- 1} ( Φ ( \frac{l - μ}{σ} ) + x ( Φ ( \frac{l - μ}{σ} ) - Φ ( \frac{l - μ}{σ} ) ) ) σ + μ \qquad ( 4 )$$

The reinforcement learning apparatus may extract actions from the CDF of the PDF of a truncated normal distribution. When the actions are extracted using the truncated normal distribution, the potential distortion and bias caused by the normal distribution's extraction of out-of-bound actions and the post-processing used to deal with this problem may be prevented.

In a system following the general setup of deep reinforcement learning, when there are a state space S and a continuous action space A, an action a∈A is extracted as a~π(s) by observing a state s∈S by using a neural network-based policy π.

In this case, when deep neural networks responsible for two parameters p and 6 are denoted by g_{μ}(s) and g_{σ}(s), respectively, a policy based on a truncated normal distribution may be represented by Equation 5 below:

$$π ( s ) = f ( x ; μ = \frac{u - l}{2} \cdot ( tanh ( {g}_{μ} ( s ) ) + 1 ) + l , σ = {g}_{σ} ( s ) , l , u ) \qquad ( 5 )$$

In this case, the reason why g_{μ}(s) is subjected to the above transformation equation is to ensure mathematical stability by limiting the μ value of the truncated normal distribution to the values between l and u.

Although a plain truncated normal distribution may be directly implemented and used as a policy, action bias may be mitigated by performing modification based on the parameters μ and σ of the plain truncated normal distribution.

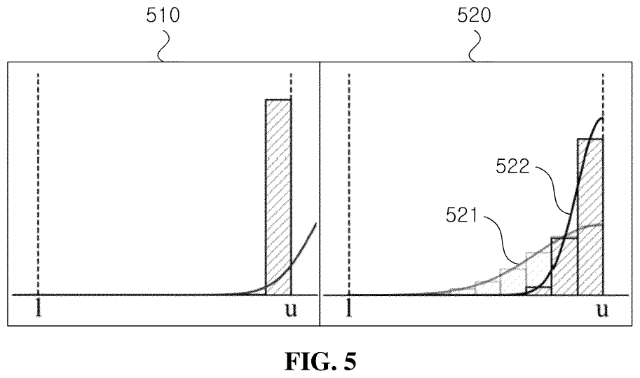

FIG. 5 is a graph illustrating a normal distribution policy 510 and a truncated normal distribution policy 520 when the location is extreme. The normal distribution policy 510 may decisively sample boundary actions, while the plain truncated normal distribution policy 521 inevitably allows more within-boundary actions due to location limitation. When the scale of the plain truncated normal distribution policy 521 is adjusted, the modified truncated normal distribution policy 522 may more accurately sample boundary actions.

The plain truncated normal distribution may cause extracted values to be excessively concentrated within the boundaries. Accordingly, this characteristic may be mitigated by using σ′=σ·d(μ), scale-adjusted according to the scale-adjustment function d(μ), as a scale parameter.

The corresponding scale adjustment has a mechanism that ensures minimal scale adjustment to σ when μ is centered between l and u. Meanwhile, in this mechanism, as μ moves away from the center toward either l or u, σ undergoes increasingly smaller scale adjustment. Depending on the μ value, it shifts left or right. As σ increases, the shape becomes lower and wider; as σ decreases, the shape becomes higher and narrower.

The scale-adjustment function is represented by Equation 6 below:

$${σ}^{′} = σ \cdot d \qquad ( 6 )$$

$$d ( μ ; l , u ) = \frac{\sqrt[k]{\vert {( \frac{u - l}{2} )}^{k} - {( μ - \frac{u + 1}{2} )}^{k} \vert}}{( u - l ) / 2} \cdot ( 1 - {d}_{min} ) + {d}_{min} \qquad ( 7 )$$

k>0, dₘᵢₙ>0 are hyperparameters, k adjusts the kurtosis of the scale-adjustment function, and dₘᵢₙ adjusts the minimum value of the scale-adjustment function. For a continuous function in the form of a semi-ellipse centered at (u+l)/2 and having a major axis u−l, the full discount of scale is not available because σ′>0. A minimum amount of discounting ratio dₘᵢₙ is set and applied to the semi-ellipse.

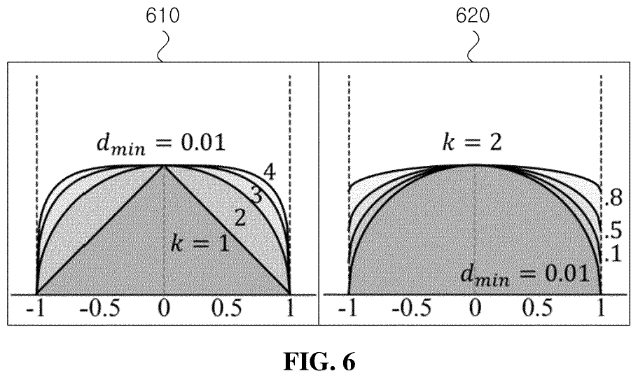

FIG. 6 is a graph illustrating the scale-adjustment functions processed by a reinforcement learning apparatus according to an embodiment.

Referring to reference numeral 610, when l=−1, u−1, dₘᵢₙ is fixed, and k is changed. Referring to reference numeral 620, when l=−1, u−1, k is fixed, and dₘᵢₙ is changed. The x axis represents μ. The shape of the scale-adjustment function changes depending on the values of k and dₘᵢₙ. The hyperparameters k and dₘᵢₙ of d(μ) generally perform well within the error ranges of k=2 and dₘᵢₙ=0.01, respectively. However, when necessary, adjusting the values based on the characteristics of the learning environment may be more advantageous. When 0<k<2, the scale is adjusted globally. In contrast, when k>2, the scale is adjusted more intensively around the boundaries than at the neutral position.

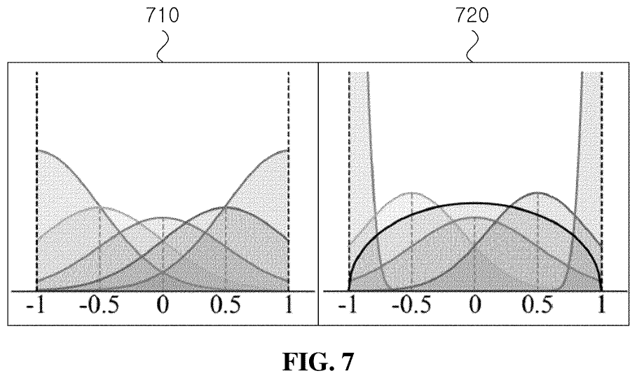

FIG. 7 is a graph illustrating truncated normal distribution policies to which the scale-adjustment functions processed by a reinforcement learning apparatus according to an embodiment are applied. The x axis is μ.

The reinforcement learning apparatus may scale-adjust the truncated normal distribution by multiplying the scale parameter σ by the scale-adjustment function d(μ). When the scale-adjusted truncated normal distribution policy π is implemented using a neural network g, it is represented by Equation 8 below:

$$π ( s ) = f ( x ; μ = \frac{u - l}{2} \cdot ( tanh ( {g}_{μ} ( s ) ) + 1 ) + l , σ = {g}_{σ} ( s ) \cdot d ( μ ) , l , u ) \qquad ( 8 )$$

When the plain truncated normal distribution 710 and the scale-adjusted truncated normal distribution 720 to which a scale-adjustment function is applied are compared with each other, it can be observed that the scale-adjustment function is applied to the truncated normal distribution policy and, thus, actions are more precisely extracted near the boundaries.

s is the state value given to an agent at each moment. The agent extracts actions according to the policy π(s) and performs reinforcement learning.

Although the truncated normal distribution has the positive function of preventing action bias by limiting the domain, it may also have the negative function of causing actions to be excessively concentrated within the boundaries. Accordingly, the concentration within the boundaries may be appropriately controlled through scale adjustment. In other words, when the scale-adjustment process is applied to the truncated normal distribution policy, both action bias toward the boundaries and action bias within the boundaries are mitigated, thereby minimizing the biased impact of the policy distribution on the reinforcement learning process.

The truncated normal distribution uses the same parameters as the normal distribution, i.e., μ and σ. The truncated normal distribution inherits unimodality, which is a representative characteristic of a normal distribution, the characteristic of forming a peak at μ, and the characteristic of varying the width of the distribution depending on the value of σ. In other words, the truncated normal distribution is similar to the normal distribution in many respects, except for its characteristic of limiting the domain of the normal distribution.

These characteristics of the truncated normal distribution enhance practical usability by inherently limiting the range of values that can be extracted while utilizing the strong generality characteristic of the normal distribution. Furthermore, the counter bias of the truncated normal distribution, which may cause extracted values to be excessively concentrated within the boundaries, is offset by the scale-adjustment function d(μ), thereby allowing the advantage to be utilized without adverse side effects.

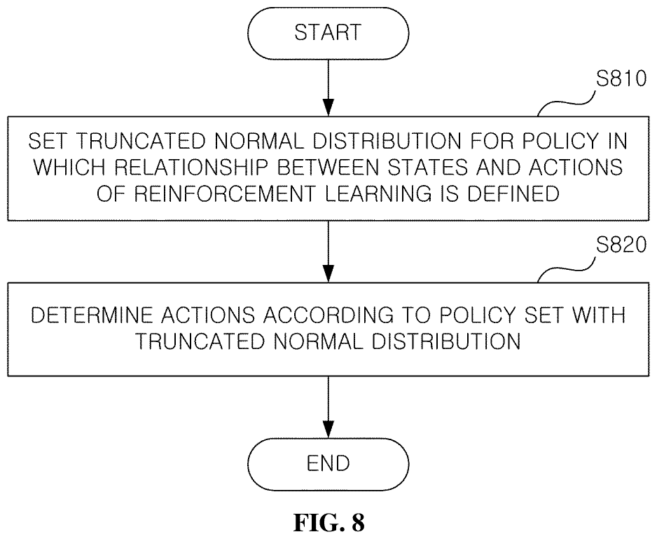

FIGS. 8 to 10 are flowcharts illustrating a reinforcement learning method according to an embodiment.

The reinforcement learning method according to the embodiment shown in FIGS. 8 to 10 includes steps that are processed in a time-series manner in the reinforcement learning apparatus shown in FIGS. 1 to 7. Accordingly, the descriptions that are omitted below but have been given above in conjunction with the reinforcement learning apparatus shown in FIGS. 1 to 7 may also be applied to the reinforcement learning method according to the embodiment shown in FIGS. 8 to 10.

Referring to FIG. 8, in step S810, the reinforcement learning apparatus sets a truncated normal distribution, which is a normal distribution having a finite domain, for a policy in which the relationship between the states and actions of reinforcement learning are defined.

In step S820, the reinforcement learning apparatus determines actions according to the policy set with the truncated normal distribution.

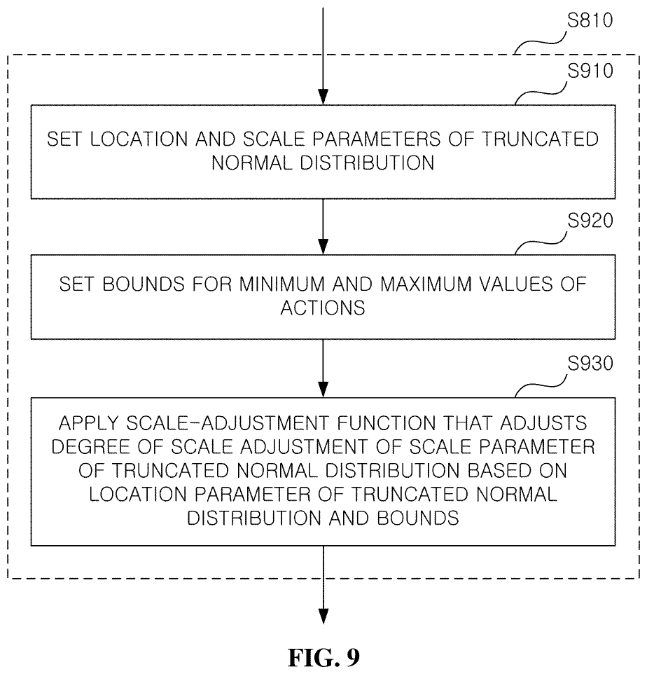

Referring to FIG. 9, step S810 of setting a truncated normal distribution may include step S910 of setting the location and scale parameters of the truncated normal distribution, step S920 of setting bounds for the minimum and maximum values of the actions, and step S930 of applying a scale-adjustment function that adjusts the degree of scale adjustment of the scale parameter of the truncated normal distribution based on the location parameter of the truncated normal distribution and the bounds.

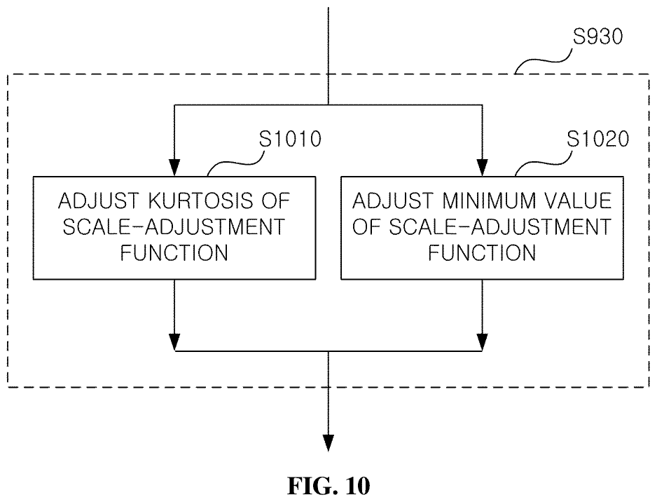

Referring to FIG. 10, step S930 of applying the scale-adjustment function may include step S1010 of controlling the bias of the actions by adjusting the kurtosis of the scale-adjustment function, and step S1020 of controlling the bias of the actions by adjusting the minimum value of the scale-adjustment function.

Step S820 of determining actions according to the policy may include the step of probabilistically extracting actions according to a policy set with a truncated normal distribution to which a scale-adjustment function is applied.

These embodiments may be applied to reinforcement learning environments having continuous action probabilities, and may control action bias attributable to a normal distribution policy in a balanced manner in various fields such as robotics applications (motor learning, manipulation ability learning, or the like), autonomous driving, trading markets, and/or the like.

The term “unit” used in the above-described embodiments means software or a hardware component such as a field-programmable gate array (FPGA) or application-specific integrated circuit (ASIC), and a “unit” performs a specific role. However, a “unit” is not limited to software or hardware. A “unit” may be configured to be present in an addressable storage medium, and also may be configured to run one or more processors. Accordingly, as an example, a “unit” includes components, such as software components, object-oriented software components, class components and task components, processes, functions, attributes, procedures, subroutines, segments in program code, drivers, firmware, microcode, circuits, data, a database, data structures, tables, arrays, and variables.

Components and a function provided in “unit(s)” may be coupled to a smaller number of components and “unit(s)” or divided into a larger number of components and “unit(s).”

In addition, components and “unit(s)” may be implemented to run one or more central processing units (CPUs) in a device or secure multimedia card.

The reinforcement learning method according to an embodiment described via the present specification may be implemented in the form of a computer-readable medium that stores instructions and data that can be executed by a computer. In this case, the instructions and the data may be stored in the form of program code, and may generate a predetermined program module and perform a predetermined operation when executed by a processor. Furthermore, the computer-readable medium may be any type of available medium that can be accessed by a computer, and may include volatile, non-volatile, separable and non-separable media. Furthermore, the computer-readable medium may be a computer storage medium.

The computer storage medium may include all volatile, non-volatile, separable and non-separable media that store information, such as computer-readable instructions, a data structure, a program module, or other data, and that are implemented using any method or technology. For example, the computer storage medium may be a magnetic storage medium such as an HDD, an SSD, or the like, an optical storage medium such as a CD, a DVD, a Blu-ray disk or the like, or memory included in a server that can be accessed over a network.

Furthermore, the reinforcement learning method according to an embodiment described via the present specification may be implemented as a computer program (or a computer program product) including computer-executable instructions. The computer program includes programmable machine instructions that are processed by a processor, and may be implemented as a high-level programming language, an object-oriented programming language, an assembly language, a machine language, or the like. Furthermore, the computer program may be stored in a tangible computer-readable storage medium (for example, memory, a hard disk, a magnetic/optical medium, a solid-state drive (SSD), or the like).

Accordingly, reinforcement learning method according to an embodiment described via the present specification may be implemented in such a manner that the above-described computer program is executed by a computing apparatus. The computing apparatus may include at least some of a processor, memory, a storage device, a high-speed interface connected to memory and a high-speed expansion port, and a low-speed interface connected to a low-speed bus and a storage device. These individual components are connected using various buses, and may be mounted on a common motherboard or using another appropriate method.

In this case, the processor may process instructions within a computing apparatus. An example of the instructions is instructions which are stored in memory or a storage device in order to display graphic information for providing a Graphic User Interface (GUI) onto an external input/output device, such as a display connected to a high-speed interface. As another embodiment, a plurality of processors and/or a plurality of buses may be appropriately used along with a plurality of pieces of memory. Furthermore, the processor may be implemented as a chipset composed of chips including a plurality of independent analog and/or digital processors.

Furthermore, the memory stores information within the computing device. As an example, the memory may include a volatile memory unit or a set of the volatile memory units. As another example, the memory may include a non-volatile memory unit or a set of the non-volatile memory units.

Furthermore, the memory may be another type of computer-readable medium, such as a magnetic or optical disk.

In addition, the storage device may provide a large storage space to the computing device. The storage device may be a computer-readable medium, or may be a configuration including such a computer-readable medium. For example, the storage device may also include devices within a storage area network (SAN) or other elements, and may be a floppy disk device, a hard disk device, an optical disk device, a tape device, flash memory, or a similar semiconductor memory device or array.

The above-described embodiments are intended for illustrative purposes. It will be understood that those having ordinary knowledge in the art to which the present invention pertains can easily make modifications and variations without changing the technical spirit and essential features of the present invention. Therefore, the above-described embodiments are illustrative and are not limitative in all aspects. For example, each component described as being in a single form may be practiced in a distributed form. In the same manner, components described as being in a distributed form may be practiced in an integrated form.

The scope of protection pursued through the present specification should be defined by the attached claims, rather than the detailed description. All modifications and variations which can be derived from the meanings, scopes and equivalents of the claims should be construed as falling within the scope of the present invention.

What is claimed is:

1. A reinforcement learning method, the reinforcement learning method being performed by a reinforcement learning apparatus, the reinforcement learning method comprising:
setting a truncated normal distribution, which is a normal distribution having a finite domain, for a policy in which a relationship between states and actions of reinforcement learning is defined; and
determining actions according to the policy set with the truncated normal distribution.

2. The reinforcement learning method of claim 1, wherein setting the truncated normal distribution comprises:
setting location and scale parameters of the truncated normal distribution; and
setting bounds for minimum and maximum values of the actions.

3. The reinforcement learning method of claim 2, wherein setting the truncated normal distribution comprises applying a scale-adjustment function that adjusts a degree of scale adjustment of the scale parameter of the truncated normal distribution based on the location parameter of the truncated normal distribution and the bounds.

4. The reinforcement learning method of claim 3, wherein applying the scale-adjustment function comprises controlling a bias of the actions by adjusting a kurtosis of the scale-adjustment function.

5. The reinforcement learning method of claim 3, wherein applying the scale-adjustment function comprises controlling a bias of the actions by adjusting a minimum value of the scale-adjustment function.

6. The reinforcement learning method of claim 3, wherein determining actions according to the policy comprises probabilistically extracting the actions according to the policy set with the truncated normal distribution to which the scale-adjustment function is applied.

7. A reinforcement learning apparatus comprising:
memory configured to store a truncated normal distribution, which is a normal distribution having a finite domain, for a policy in which a relationship between states and actions of reinforcement learning is defined; and
a controller configured to determine the actions according to the policy set with the truncated normal distribution.

8. The reinforcement learning apparatus of claim 7, wherein the controller is further configured to:
set location and scale parameters of the truncated normal distribution;
set bounds for minimum and maximum values of the actions; and
apply a scale-adjustment function that adjusts a degree of scale adjustment of the scale parameter of the truncated normal distribution based on the location parameter of the truncated normal distribution and the bounds.

9. A non-transitory computer-readable storage medium having stored thereon a program for performing the method set forth in claim 1.

10. A computer program stored on a storage medium to perform the method set forth in claim 1, the computer program being executed by a reinforcement learning apparatus.
